(19) United States
(12) Patent Application Publication
(10) Pub. No.: US 2018/0272630 A1
(43) Pub. Date: Sep. 27, 2018

(54) Method for Manufacturing Composite Structure

(71) Applicant: AISIN TAKAOKA CO., LTD., Toyota-shi (JP)

(72) Inventors: Kiyohito KONDO, Toyota-shi (JP); Yuji YAMASHITA, Toyota-shi (JP); Shigenari NARAHARA, Toyota-shi (JP)

(73) Assignee: AISIN TAKAOKA CO., LTD., Toyota-shi (JP)

(21) Appl. No.: 15/924,655

(22) Filed: Mar. 19, 2018

(30) Foreign Application Priority Data
Mar. 22, 2017 (JP) 2017-056467

(51) Int. Cl. B29C 70/78; B29C 70/68; B29C 70/46

(52) U.S. Cl. CPC B29C 70/78; B29K 2101/10; B29C 70/462; B29C 70/682

(57) ABSTRACT

A metal plate, a fabric formed of reinforcing fibers, and thermosetting adhesives are layered on each other in a die in a die clamping direction. The thermosetting adhesives are forced to enter the fabric by clamping the die to produce a fiber reinforced plastic material with the thermosetting adhesives therein being in an uncured state. At the same time, the fiber reinforced plastic material is molded into a shape specified by the die. The thermosetting adhesives are allowed to cure in the die to cure the molded fiber reinforced plastic material, and the fiber reinforced plastic material and the metal plate are bonded each other.

### CROSS REFERENCE TO RELATED APPLICATION

The present application is based on Japanese Patent Application No. 2017-56467 filed on Mar. 22, 2017, and the entire content described therein is incorporated in the present specification.

### BACKGROUND OF THE INVENTION

### 1. Field of the Invention

The present disclosure relates to a method for manufacturing a composite structure formed of a metal member and a fiber reinforced plastic material.

### Description of the Related Art

### 2. Background Art

As a method for manufacturing a composite structure, there are known methods disclosed, for example, in Japanese Patent Laid-Open No. 6-101732, International Publication No. WO 99/10168, and U.S. Pat. No. 7,077,438. In each of the manufacturing methods, a prepreg formed of reinforcing fibers impregnated with a matrix resin is used to produce a fiber reinforced plastic material. Further, the fiber reinforced plastic material is molded into a desired shape and then bonded to a metal member with an adhesive.

Japanese Patent No. 5674748 discloses that a thermosetting matrix resin with which a prepreg is impregnated is used to bond the fiber reinforced plastic material and a metal member to each other. In this method, the prepreg and the metal member are layered on each other and pressurized, and the matrix resin having exuded into the boundary between the prepreg and the metal member is cured to bond the prepreg and the metal member to each other.

In the manufacturing methods described in Japanese Patent Laid-Open No. 6-101732, International Publication No. WO 99/10168, and U.S. Pat. No. 7,077,438, the step of forming a prepreg that serves as a precursor of the fiber reinforced plastic material, the step of molding the fiber reinforced plastic material, and the step of bonding the molded body and the metal member to each other need to be separately carried out. A large number of steps are therefore required, resulting in a concern about a decrease in manufacturing efficiency.

On the other hand, according to the manufacturing method described in Japanese Patent No. 5674748, the bonding step described above can be omitted, but the bonding strength between the fiber reinforced plastic material and the metal member could be inferior to the bonding strength in the case where an adhesive is used.

The present disclosure has been made in view of the circumstances described above, and an object of the present disclosure is to provide a composite structure manufacturing method that allows improvement in manufacturing efficiency while increasing the bonding strength between a fiber reinforced plastic material and a metal member.

### SUMMARY OF THE INVENTION

To achieve the object described above, a first manufacturing method is a method for manufacturing a composite structure formed of a metal member and a fiber reinforced plastic material, the method including a first step of layering the metal member, reinforcing fibers, and a resin-based adhesive on each other in a die in a die clamping direction, a second step of forcing the resin-based adhesive to enter spaces between the reinforcing fibers by clamping the die to produce the fiber reinforced plastic material with the resin-based adhesive therein being in an uncured state and molding the fiber reinforced plastic material into a shape specified by the die, and a third step of curing the resin-based adhesive in the die to cure the molded fiber reinforced plastic material and bonding the fiber reinforced plastic material and the metal member to each other.

According to the first manufacturing method, the impregnation of the reinforcing fibers with the resin, the molding of the fiber reinforced plastic material, and the bonding between the molded piece and the metal member can be performed in the same die through the series of steps, whereby the number of steps of manufacturing the composite structure can be reduced, and the manufacturing efficiency can be increased. Further, since the adhesive is used as the resin with which the reinforcing fibers are impregnated, the bonding strength between the fiber reinforced plastic material and the metal member can be increased as compared with the case in related art where the bonding is performed by using a matrix resin.

In a second manufacturing method, the resin-based adhesive is disposed between the metal member and the reinforcing fibers in the first step.

According to the second manufacturing method, the resin-based adhesive is likely to be present between the metal member and the fiber reinforced plastic material after the forced entry of the resin-based adhesive, whereby the metal member and the fiber reinforced plastic material can be bonded to each other in a satisfactory manner.

In a third manufacturing method, the resin-based adhesive is disposed on opposite sides across the reinforcing fibers in the die clamping direction in the first step.

According to the third manufacturing method, the distance over which the resin-based adhesive flows through the reinforcing fibers can be reduced, whereby the resin-based adhesive can be filled into a whole inside of the reinforcing fibers and the uniform density of the adhesive can be facilitated.

In a fourth manufacturing method, the reinforcing fibers layered in the first step are formed of a multi-fabric.

For example, in a case where cloth-shaped unit fabrics are layered on each other in a molding process, a boundary is created between adjacent fabrics in the layered direction, and the strength tends to lower in the boundary. In this regard, according to the fourth manufacturing method, the reinforcing fibers three-dimensionally interface with one another in the fabric, whereby the strength of the fiber reinforced plastic material can be increased.

In a fifth manufacturing method, the resin-based adhesive is a thermosetting resin-based adhesive, the resin-based adhesive in an uncured state is layered in the first step, and the die is pre-heated before the second step.

A thermosetting adhesive in an uncured state is characterized in that when it is heated, the viscosity thereof temporarily lowers and then it cures. According to the fifth manufacturing method, in which the resin-based adhesive is heated before the die is clamped, the die is clamped with the flowability of the resin-based adhesive increased. As a result, the resin-based adhesive readily flows when the die is clamped, whereby the resin-based adhesive is allowed to be filled into a whole inside of the reinforcing fibers.

As described above, according to the present disclosure, composite structure manufacturing efficiency can be improved with the bonding strength between the fiber reinforced plastic material and the metal member increased.

The object described above and other objects, features, and advantages of the present disclosure will be apparent from the following detailed description with reference to the accompanying drawings.

### BRIEF DESCRIPTION OF THE DRAWINGS

FIG. 1(A) is a perspective view showing a schematic configuration of a composite structure according to an embodiment of the present disclosure, and FIG. 1(B) is a cross-sectional view taken along the line A-A in FIG. 1(A);

FIGS. 2(A) to (E) are descriptive diagrams for describing the steps of manufacturing the composite structure;

FIG. 3(A) is a perspective view of a composite structure shown in a first application example, and FIG. 3(B) is a descriptive diagram for describing the method for manufacturing the composite structure;

FIG. 4(A) is a perspective view of a composite structure shown in a second application example, and FIG. 4(B) is a descriptive diagram for describing the method for manufacturing the composite structure; and

FIG. 5(A) is a perspective view of a composite structure shown in a third application example, and FIG. 5(B) is a descriptive diagram for describing the method for manufacturing the composite structure.

### DETAILED DESCRIPTION OF THE PREFERRED EMBODIMENT

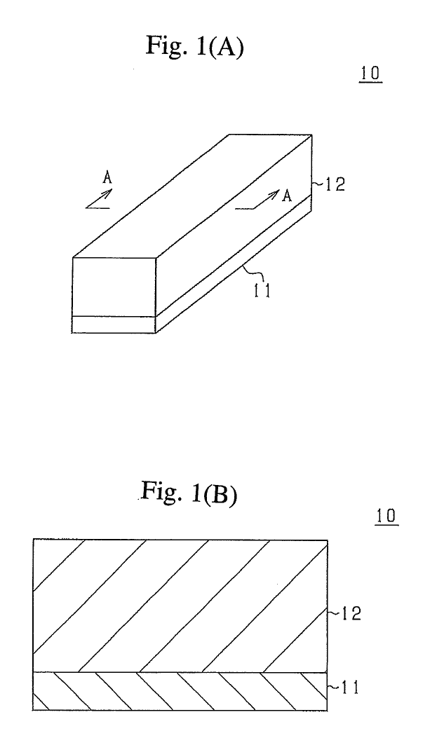

An embodiment in which the present disclosure is embodied will be described below with reference to the drawings. FIG. 1(A) is a perspective view showing a schematic configuration of a composite structure 10, and FIG. 1(B) is a cross-sectional view taken along the line A-A in FIG. 1(A).

The composite structure 10 includes a metal plate 11 as a metal member and a fiber reinforced plastic (CFRP) material 12 and has as a whole a roughly rectangular columnar shape extending in the frontward/rearward direction.

The fiber reinforced plastic material 12 is a composite material made of reinforcing fibers and a resin. In the present embodiment, a resin-based adhesive is used as the resin. That is, in place of a matrix resin in related art, the fiber reinforced plastic material 12 is formed by using the resin-based adhesive as a matrix. The resin-based adhesive is a thermosetting resin-based adhesive (hereinafter referred to as “thermosetting adhesive”) and is specifically formed, for example, of an epoxy-resin-based adhesive.

The metal plate 11 and the fiber reinforced plastic material 12 are bonded to each other, and the bonding is performed by using the thermosetting adhesive contained in the fiber reinforced plastic material 12.

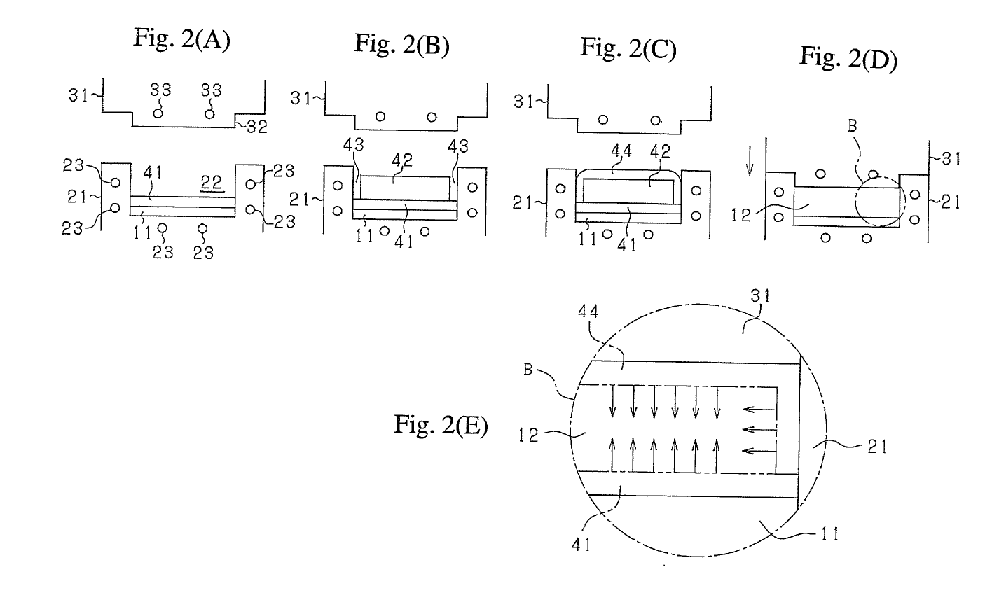

A method for manufacturing the composite structure 10 having the configuration described above will next be described with reference to FIGS. 2(A) to (E). FIGS. 2(A) to (E) are descriptive diagrams for describing the steps of manufacturing the composite structure 10.

Out of a pair of dies, a lower die 21, which is a fixed die, is provided with a recess (cavity) 22 formed in correspondence with the shape of the composite structure 10 (roughly rectangular columnar shape). A plurality of heaters 23 are disposed in the lower die 21 and along the inner surface of the cavity 22.

An upper die 31, which is a movable die out of the pair of dies, has a protrusion 32 so formed as to correspond to the cavity 22 of the lower die 21. The lower end surface of the protrusion 32 is a shaping surface that shapes the upper surface of the composite structure 10, and the shaping surface is a flat surface. A plurality of heaters 33 are disposed in the upper die 31 in correspondence with the protrusion 32.

To manufacture the composite structure 10, the heaters 23 and 33 in the lower die 21 and the upper die 31 are turned on to first preheat the dies. The temperature of the dies in this process is set at a temperature necessary to cure the thermosetting adhesive and is specifically higher than the curing temperature thereof.

The metal plate 11 is then disposed in the cavity 22 of the lower die 21, and a thermosetting adhesive 41 in an uncured (gel) state is applied onto the metal plate 11, as shown in FIG. 2(A). In this process, the thermosetting adhesive 41 is applied over the entire upper surface of the metal plate 11 to a roughly uniform thickness. The metal plate 11 and the thermosetting adhesive 41 may be so disposed in the lower die 21 that the metal plate 11 is disposed in the cavity 22 and then the thermosetting adhesive 41 is applied onto the metal plate 11, or the metal plate 11 onto which the thermosetting adhesive 41 has been applied in advance is placed in the cavity 22.

A block-shaped fabric 42 having a predetermined thickness is then disposed on the thermosetting adhesive 41, as shown in FIG. 2(B). The fabric 42 is not impregnated with a matrix resin, unlike a prepreg in related art.

The fabric 42 described above is formed of reinforcing fibers and specifically produced by combining carbon fibers, glass fibers, or any other inorganic fibers with aramid fibers or any other organic fibers and weaving the two types of fibers. Further, the fabric 42 is configured as a multi-fabric. A multi-fabric is formed by layering a plurality of fabric textures (unit fabrics) each formed of a set of warp and weft on each other and connecting the fabric textures to each other with the weaving yarns that form each of the unit fabrics. That is, in the fabric 42, the reinforcing fibers interlace (are entangled) with one another also in the thickness direction.

The fabric 42 is configured to be thicker than a molded piece (portion that forms fiber reinforced plastic material 12 out of composite structure 10). Further, the fabric 42 is configured to be smaller than the cavity 22 in the rightward/leftward and frontward/rearward directions so that a gap 43 is formed between the fabric 42 and the inner circumferential surface of the cavity 22 in the rightward/leftward and frontward/rearward directions of the fabric 42. In the present embodiment, only one thus dimensioned fabric 42 is disposed in the cavity 22. A post-molding situation in which the boundaries between the fabrics are created is thus avoided.

Subsequently, a thermosetting adhesive 44 in an uncured state is applied onto the fabric 42, as shown in FIG. 2(C). The thermosetting adhesive 44 is an adhesive identical to the thermosetting adhesive 41 and is applied over the entire upper surface of the fabric 42 to a roughly uniform thickness. In this process, the thermosetting adhesive 44 is caused to flow also into the gap 43 formed around the fabric 42, so that the thermosetting adhesive 44 is in contact also with the circumferential surface of the fabric 42. The total amount of applied thermosetting adhesives 41 and 44 is determined from a target Vf value (volumetric ratio between reinforcing fibers and resin) of the fiber reinforced plastic material 12.

The lower die 21 and the upper die 31 are then combined with each other to achieve die clamping and press the metal plate 11, the thermosetting adhesive 41, the fabric 42, and the thermosetting adhesive 44 in the direction in which they are layered on each other so that they contract in the direction, as shown in FIG. 2(D). As a result, the thermosetting adhesives 41 and 44 are forced to enter the gap between the fibers in the fabric 42. Since the thermosetting adhesive 44 has been applied onto the front, rear, right, and left side surfaces of the fabric 42, the thermosetting adhesives 41 and 44 are forced to enter the fabric 42 not only from above and below but from the front, rear, right and left sides, as shown in FIG. 2(E). The present step allows the fabric 42 to be impregnated with the thermosetting adhesives 41 and 44, whereby the fiber reinforced plastic material 12 in an uncured state is produced.

At the same time, in the present step, the fiber reinforced plastic material 12 is molded into the shape determined by the shaping surfaces of the cavity 22 and the protrusion 32 (rectangular columnar shape in present embodiment). In this process, the fabric 42 expands in the frontward/rearward and rightward/leftward directions due to its internal stress while pressed and hence contracting in the upward/downward direction (die clamping direction) due to die clamping force. In this case, for example, if no gap 43 described above is provided around the fabric 42, the fabric 42 is strongly pressed against the inner circumferential surface of the cavity 22, so that the fiber density in an outer circumferential portion of the fabric 42 is likely to be higher than that in the other portion of the fabric 42. As a result, in the outer circumferential portion, an area into which the thermosetting adhesives flow is crushed, and the impregnation of the fabric 42 with the adhesives could be undesirably hindered. In this regard, in the present embodiment, in which the gap 43 described above is provided around the fabric 42, the outer circumferential portion of the fabric 42 can also be impregnated with the thermosetting adhesives in a satisfactory manner.

As described above, in the present embodiment, the dies are pre-heated before the die clamping step, whereby the fabric 42 can be impregnated with the thermosetting adhesives 41 and 44 in a satisfactory manner. That is, a thermosetting adhesive in an uncured state is characterized in that when it is heated, the viscosity thereof temporarily lowers and then it cures, and in the present embodiment, in which the thermosetting adhesives 41 and 44 are heated before the dies are clamped, the dies are clamped with the flowability of the thermosetting adhesives increased. As a result, the thermosetting adhesives 41 and 44 readily flow when the dies are clamped, whereby the thermosetting adhesives are allowed to be filled into a whole inside of the fabric 42.

In a case where the thermosetting adhesives 41 and 44 start curing at the beginning of or during the die clamping, the dies may be heated stepwise. For example, in the placement step and the die clamping step, the die temperature can be adjusted to a temperature lower than the curing temperature, and in the curing step, the die temperature can be adjusted to the curing temperature or a temperature higher than the curing temperature. In this configuration, the timing when thermosetting adhesives 41 and 44 start curing can be delayed with the flowability thereof in the die clamping step increased.

Thereafter, the temperature of the dies is maintained for a predetermined period by heaters 23 and 33 with the lower die 21 and the upper die 31 clamped. As a result, the curing reaction of the thermosetting adhesives 41 and 44 advances, and the thermosetting adhesives 41 and 44 cure. The shape of the fiber reinforced plastic material 12 is therefore stabilized, and the thermosetting adhesives present in the boundary region between the metal plate 11 and the fiber reinforced plastic material 12 securely bonds them to each other.

In the present embodiment, a poor-adhesiveness layer is provided on the shaping surfaces of the lower die 21 and the upper die 31 (inner surface of cavity 22 and outer surface of protrusion 32). The poor-adhesiveness layer is formed by coating a poor-adhesiveness substance (silicon or fluorine, for example), which has low mutually solubility with the thermosetting adhesives, on the entire shaping surfaces described above. Providing the poor-adhesiveness layer can avoid an inconvenient situation in which the thermosetting adhesives bond the fiber reinforced plastic material 12 to the dies.

Finally, the dies are unclamped, and the molded piece is removed. The composite structure 10 is thus completed.

The present embodiment described above in detail provides the following excellent effects:

The fabric 42 with which no resin is impregnated and the thermosetting adhesives 41 and 44 in an uncured state are disposed on the metal plate 11 in the dies, and the dies are clamped in this state. Therefore, the fabric 42 is impregnated with the thermosetting adhesives 41 and 44, and the fiber reinforced plastic material 12 is molded at the same time. Further, the thermosetting adhesives are caused to cure in the dies to allow the metal plate 11 and the fiber reinforced plastic material 12 to be bonded to each other while the fiber reinforced plastic material 12 cures. The procedure from “the impregnation of the fabric 42 (reinforcing fibers) with the resin” to “the bonding between the metal plate 11 and the fiber reinforced plastic material 12” can be performed in the same dies through the series of steps, whereby the number of steps can be reduced. Further, since the adhesives are used as the resin with which the fabric 42 is impregnated, the metal plate 11 and the fiber reinforced plastic material 12 can be bonded to each other based on the bonding function inherent in the adhesive. The bonding strength between the metal plate 11 and the fiber reinforced plastic material 12 can therefore be increased as compared with the case in related art where the bonding is performed by using a matrix resin.

In the case where the thermosetting adhesive 41 is placed in the dies, the thermosetting adhesive 41 is disposed between the metal plate 11 and the fabric 42. In this case, the thermosetting adhesive 41 is forced to enter the fabric 42 from the boundary region as a start point between the metal plate 11 and the fabric 42, and the thermosetting adhesive 41 is therefore likely to be present between the metal plate 11 and the fabric 42 (fiber reinforced plastic material 12) after the forced entry, whereby the metal plate 11 and the fabric 42 (fiber reinforced plastic material 12) can be bonded to each other in a satisfactory manner.

In the case where the thermosetting adhesive 41 is placed in the dies, the thermosetting adhesive 44 is disposed also on the fabric 42. For example, in a case where the thermosetting adhesives are forced to enter the fabric 42 only from one side thereof, the thermosetting adhesives flow through the fabric 42 over a long distance. In this case, there is a concern about situations in which the thermosetting adhesives do not reach the other side of the fabric 42 and the adhesives are non-uniformly distributed in the fabric 42. In this regard, forcing the thermosetting adhesives 41 and 44 to enter the fabric 42 from the opposite sides thereof allows the thermosetting adhesives 41 and 44 to flow over a shorter distance and to be filled into a whole inside of the fabric 42, and the uniform density of the adhesives to be facilitated.

The fabric 42 is formed of a multi-fabric, and only one multi-fabric is placed in the dies. For example, in a case where cloth-shaped unit fabrics are layered on each other in a molding process, a boundary portion between where the reinforcing fibers do not interlace with one another is created between adjacent unit fabrics. In this case, the fabrics are bonded to each other only with the adhesive force of the adhesives in the boundary portion, so that the strength of the bonded fabrics in the bonding direction tends to be lower than the in-plane strength of the unit fabrics. In this regard, according to the configuration of the present embodiment, the reinforcing fibers three-dimensionally interface with one another in the fabric 42, and no boundary between the fabrics 42 is created. The boundary portion such in related art is not therefore created, whereby the strength of the fiber reinforced plastic material 12 can be increased.

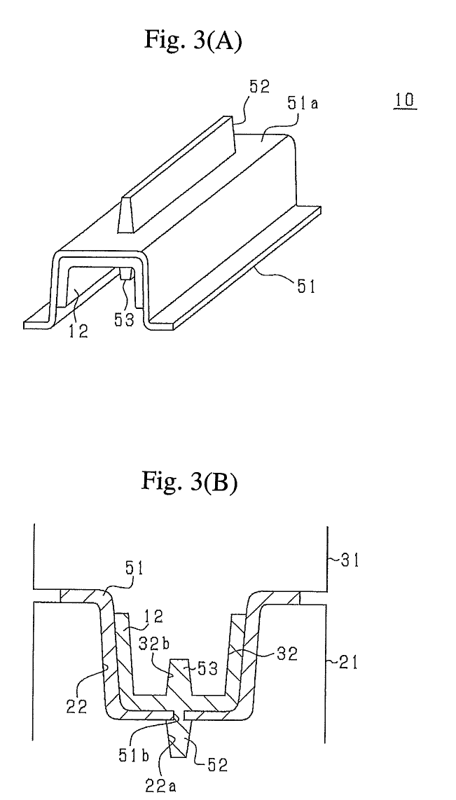

Examples to which the composite structure 10 and the method for manufacturing the same described above are applied will next be described with reference to FIGS. 3(A) and 3(B) to FIGS. 5(A) and 5(B). FIGS. 3(A) and 3(B) to FIGS. 5(A) and 5(B) are schematic views showing first to third application examples, respectively. In FIGS. 3(A) and 3(B) to FIGS. 5(A) and 5(B), FIGS. 3(A), 4(A), and 5(A) are perspective views of the composite structure 10 according to the respective application examples, and FIGS. 3(B), 4(B), and 5(B) are descriptive diagrams for describing the manufacturing methods in the respective application examples. In FIGS. 3(B), 4(B), and 5(B), to readily allow the members of the composite structure 10 to be distinguished from the members of the dies, the former members are hatched. Further, the heaters 23 and 33 are omitted in FIGS. 3(B) to FIGS. 5(B).

In the composite structure 10 according to the first application example shown in FIG. 3(A), a metal member 51, which corresponds to the metal plate 11, is molded into a hat-shaped member. Further, a top plate section 51a of the metal member 51 has a through hole 51b, which passes through the top plate section 51a in the thickness direction (see FIG. 3(B)). The fiber reinforced plastic material 12 is provided with ribs 52 and 53, which protrude upward and downward, and the rib 52 out of the two ribs is so formed as to protrude upward beyond the metal member 51 through the through hole 51b.

To manufacture the composite structure 10 described above, the lower die 21 in which an indent 22a corresponding to the rib 52 described above is formed in the cavity 22 and the upper die 31 in which an indent 32b corresponding to the rib 53 described above is formed in the protrusion 32 are used, as shown in FIG. 3(B). The variety of steps described with reference to FIGS. 2(A) to 2(E) are then sequentially carried out. In this case, when the dies are clamped, the thermosetting adhesives pass through the through hole 51b in the metal member 51, flow into the indent 22a of the lower die 21, and form the rib 52. According to the present application example, even a composite structure 10 having a complex shape that metal molding hardly handles can be readily formed.

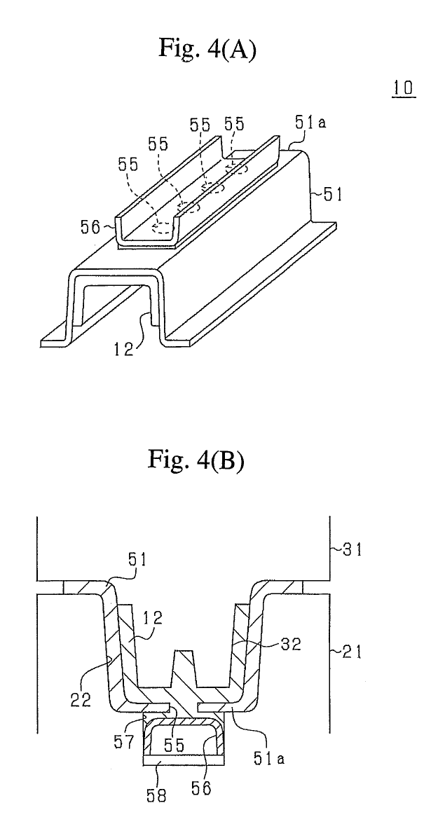

In the composite structure 10 according to the second application example shown in FIG. 4(A), a plurality of through holes 55 are formed in the top plate section 51a of the metal member 51. Further, an additional member 56, which is a metal plate bent into a U-shape, is disposed on the top plate section 51a. The additional member 56 is bonded to the metal member 51 with the thermosetting adhesives that flow through the through holes 55 from the space inside the metal member 51 into the space outside the metal member 51.

To manufacture the composite structure 10 described above, the upper die 31 according to the first application example (FIG. 3(B)) described above and the lower die 21 in which a recess 57, where the additional member 56 described above can be disposed, is formed in the cavity 22 are used, as shown in FIG. 4(B). The depth of the recess 57 is greater than the height of the additional member 56, so that when the metal member 51 is placed in the cavity 22, a gap is formed between the top plate section 51a of the metal member 51 and the additional member 56. Further, a seal 58, which prevents the thermosetting adhesives from flowing into the space inside the additional member 56, is provided at the bottom of the recess 57. The seal 58 is made, for example, of silicon rubber.

Also in the present application example, the variety of steps described with reference to FIGS. 2(A) to 2(E) are sequentially carried out to manufacture the composite structure 10. In this case, when the dies are clamped, the thermosetting adhesives pass through the through holes 55 in the metal member 51, enter the space facing the outer surface of the top plate section 51a, and fill the space between the metal member 51 and the additional member 56. Thereafter, when the thermosetting adhesives cure, the metal member 51 and the additional member 56 are bonded to each other. According to the present application example, the additional member 56 is bonded to the metal member 51 with the adhesives, whereby no mechanical linkage, for example, using bolts and nuts is required. Further, since the manufacturing of the composite structure 10 including the bonding of the additional member 56 can be performed in the series of steps, the present application example is advantageous in a case where an additional function is provided.

Further, in the present application example, the adhesives are located on both of the inner and outer sides of the metal member 51, and the adhesives are continuously present through the through holes 55 formed in the top plate section 51a. In this case, the bonding strength can be increased as compared with a case where only one-side surface (inner surface) of the metal member 51 is bonded to the fiber reinforced plastic material 12, whereby the present application example is advantageous in a case where greater strength is required.

The additional member 56 is not necessarily made of a metal and may instead be, for example, formed of a resin member or made of a fiber reinforced plastic material. Further, in place of the additional member 56, a nut or any other mechanical linkage tool may be joined to the top plate section 51a.

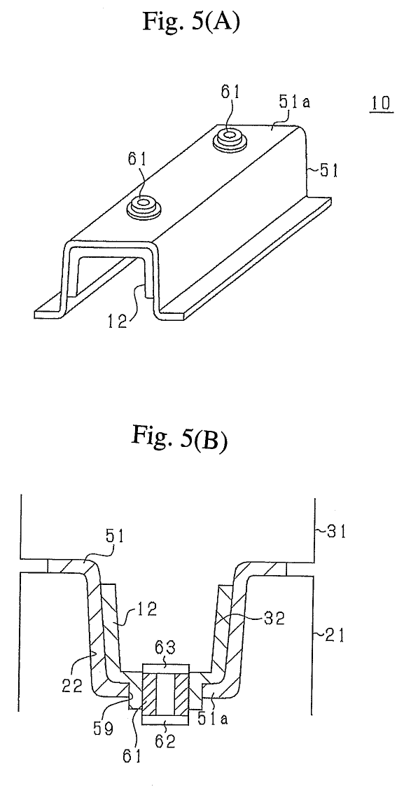

In the composite structure 10 according to the third application example shown in FIG. 5(A), through holes 59 are formed in the top plate section 51a of the metal member 51 (see FIG. 5(B)), and a nut 61 is disposed in each of the through holes 59. The diameter of the opening of each of the through holes 59 is greater than the outer diameter of the nut 61, and the nut 61 is bonded to the metal member 51 with the thermosetting adhesives that flow into the gap between the circumferential surface of the through hole 59 and the outer circumferential surface of the nut 61.

To manufacture the composite structure 10 described above, the lower die 21 and the upper die 31 provided with seals 62 and 63 in correspondence with the positions where the nuts 61 are disposed, as shown in FIG. 5(B). The seals 62 and 63 each prevent the thermosetting adhesives from flowing into the interior of the nuts 61 (threaded hole to be coupled with bolt) and are made, for example, of silicon rubber, as the seal 58 in the second application example in FIG. 4(B).

Also in the present application example, the variety of steps described with reference to FIGS. 2(A) to 2(E) are sequentially carried out to manufacture the composite structure 10. In this case, when the dies are clamped, the gaps between the circumferential surfaces of the through holes 59 and the outer circumferential surfaces of the nuts 61 are filled with the thermosetting adhesives, and the thermosetting adhesives having filled the gaps then cure, whereby the nuts 61 and the metal member 51 are bonded to each other. The present application example is advantageous in a case where the composite structure 10 is given the function that allows another member to be attached thereto. In place of the nuts 61, bolts, resin fasteners, or any other mechanical linkage tools can be joined to the top plate section 51a.

### Other Embodiments

The present disclosure is not limited to the embodiment described above and may, for example, be implemented as follows:

(1) In the embodiment described above, a thermosetting adhesive is used as the resin-based adhesive. A thermoplastic adhesive may instead be used. In this case, the metal plate 11 and the thermoplastic adhesive are placed in the dies with the temperature of the metal plate 11 and the thermoplastic adhesive adjusted (heated) to a temperature that allows the adhesive to soften. After the dies are clamped and the fabric 42 is impregnated with the thermoplastic adhesive, the dies are cooled so that the thermoplastic adhesive cures. When the thermoplastic adhesive is placed in the dies, the adhesive in an uncured state may be placed or the adhesive in a cured state may be placed. That is, the adhesive only needs to be in an uncured state in the die clamping step (step of forcing adhesive to enter fabric).

(2) In the embodiment described above, the fabric 42 is used as the reinforcing fibers. The reinforcing fibers is, however, not necessarily regularly woven and may have a structure in which the fibers are entangled (interlace) with one another into a block.

(3) In the embodiment described above, the thermosetting adhesives 41 and 44 are disposed on opposite sides across the fabric 42. Instead, the thermosetting adhesives may be disposed only between the fabric 42 and the metal plate 11, or the thermosetting adhesives may be disposed only on the fabric 42. In consideration of the adhesiveness to the metal plate 11 and the permeability of the thermosetting adhesives into the fabric 42, however, the configuration in the embodiment described above is preferable.

(4) In the embodiment described above, the thermosetting adhesive 41 is disposed between the fabric 42 and the metal plate 11. The thermosetting adhesive 41 may instead be disposed below the metal plate 11. It is preferable in this case that at least one through hole is provided in the metal plate 11 and the thermosetting adhesive 41 is allowed to flow into the fabric 42 through the through hole.

(5) In the embodiment described above, a single multi-fabric is used as the fabric 42. Instead, a plurality of unit fabrics may be layered on each other, or a plurality of multi-fabrics may be disposed.

(6) In the embodiment described above, the dies are pre-heated before the thermosetting adhesives 41 and 44 are placed in the dies. The dies may instead be pre-heated during the placement of the thermosetting adhesives 41 and 44. An important point is employing a configuration in which the thermosetting adhesives 41 and 44 are pre-heated before the dies are clamped.

The present disclosure has been described in conformity with examples but is not limited to the examples and the structures therein. Further, the present disclosure encompasses a variety of variation examples and variations in the scope of equivalents of the present disclosure. In addition, a variety of combinations and forms and even other combinations and forms to which only one element or two or more elements are added fall within the scope and ideological range of the present disclosure.

What is claimed is:

1. A method for manufacturing a composite structure formed of a metal member and a fiber reinforced plastic material, the method comprising:
a first step of layering the metal member, reinforcing fibers, and a resin-based adhesive on each other in a die in a die clamping direction;
a second step of forcing the resin-based adhesive to enter spaces between the reinforcing fibers by clamping the die to produce the fiber reinforced plastic material with the resin-based adhesive therein being in an uncured state and molding the fiber reinforced plastic material into a shape specified by the die; and
a third step of curing the resin-based adhesive in the die to cure the molded fiber reinforced plastic material and bonding the fiber reinforced plastic material and the metal member to each other.

2. The method for manufacturing a composite structure according to claim 1, wherein the resin-based adhesive is disposed between the metal member and the reinforcing fibers in the first step.

3. The method for manufacturing a composite structure according to claim 2, wherein the resin-based adhesive is disposed on opposite sides across the reinforcing fibers in the die clamping direction in the first step.

4. The method for manufacturing a composite structure according to claim 1, wherein the reinforcing fibers layered in the first step are formed of a multi-fabric.

5. The method for manufacturing a composite structure according to claim 2, wherein the reinforcing fibers layered in the first step are formed of a multi-fabric.

6. The method for manufacturing a composite structure according to claim 3, wherein the reinforcing fibers layered in the first step are formed of a multi-fabric.

7. The method for manufacturing a composite structure according to claim 1,
wherein the resin-based adhesive is a thermosetting resin-based adhesive,
the resin-based adhesive in an uncured state is layered in the first step, and
the die is pre-heated before the second step.

8. The method for manufacturing a composite structure according to claim 2,
wherein the resin-based adhesive is a thermosetting resin-based adhesive,
the resin-based adhesive in an uncured state is layered in the first step, and
the die is pre-heated before the second step.

9. The method for manufacturing a composite structure according to claim 3,
wherein the resin-based adhesive is a thermosetting resin-based adhesive,
the resin-based adhesive in an uncured state is layered in the first step, and
the die is pre-heated before the second step.

10. The method for manufacturing a composite structure according to claim 4,
wherein the resin-based adhesive is a thermosetting resin-based adhesive,
the resin-based adhesive in an uncured state is layered in the first step, and
the die is pre-heated before the second step.
